(19) United States
(12) Patent Application Publication
(10) Pub. No.: US 2018/0267992 A1
(43) Pub. Date: Sep. 20, 2018

(54) INFORMATION PROCESSING SYSTEM, INFORMATION PROCESSING METHOD, AND NON-TRANSITORY COMPUTER-READABLE RECORDING MEDIUM

(71) Applicant: YAHOO JAPAN CORPORATION, Tokyo (JP)

(72) Inventor: Shumpei OKURA, Tokyo (JP)

(73) Assignee: YAHOO JAPAN CORPORATION, Tokyo (JP)

(21) Appl. No.: 15/882,691

(22) Filed: Jan. 29, 2018

(30) Foreign Application Priority Data
Mar. 17, 2017 (JP) 2017-052364

(51) Int. Cl. G06F 17/30; H04L 29/08; G06N 99/00

(52) U.S. Cl. CPC G06F 17/30241; G06N 99/005; H04L 67/18

(57) ABSTRACT

An information processing system includes a first acquisition unit that acquires first information about the content of a content item, a second acquisition unit that acquires second information about a location of a user who has accessed the content item, and a deriving unit that derives third information based on the first information acquired by the first acquisition unit and the second information acquired by the second acquisition unit, the third information associating a factor included in the content of the content item with a specific area in which the user is located.

### CROSS-REFERENCE TO RELATED APPLICATION(S)

The present application claims priority to and incorporates by reference the entire contents of Japanese Patent Application No. 2017-052364 filed in Japan on Mar. 17, 2017.

### BACKGROUND OF THE INVENTION

### 1. Field of the Invention

The present invention relates to an information processing system, a method of information processing, and a non-transitory computer-readable recording medium having stored therein a computer program.

### 2. Description of the Related Art

Information processing systems have been developed that acquire a certain specific location corresponding to a place name by referring to dictionary data that connects a place name with a corresponding specific location (see, for example, refer to JP 2014-096121 A).

Content items including local topics may be useful to users in certain specific areas relating to the topics, but may be not to users in other areas. In this regard, before a content item about a local topic is delivered, it is preferred to specify the area relating to the content of the content item.

Specifying an area relating to the content of a content item requires dictionary data that connects a place name included in the content item with a certain specific area. Such dictionary data is manually created and requires regular maintenance. Thus, preparing a system for specifying areas relating to the content of content items requires a large amount of workload in some cases.

### SUMMARY OF THE INVENTION

It is an object of the present invention to at least partially solve the problems in the conventional technology.

An information processing system according to the present application includes a first acquisition unit that acquires first information about content of a content item, a second acquisition unit that acquires second information about a location of a user who has accessed the content item, and a deriving unit that derives third information based on the first information acquired by the first acquisition unit and the second information acquired by the second acquisition unit, the third information associating a factor included in the content of the content item with a specific area out of a plurality of specific areas.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating usage environment of an information delivery device 10 according to an embodiment;

FIG. 2 is a diagram illustrating an example of the content of an association table T1 according to the embodiment;

FIG. 3 is a diagram illustrating an example of how specific areas A are set in the embodiment;

FIG. 4 is a diagram illustrating an example of the content of an association table T2 according to the embodiment;

FIG. 5 is a diagram illustrating an example of the content of an association table T3 according to the embodiment;

FIG. 6 is a diagram illustrating an example of the content of an association table T4 according to the embodiment;

FIG. 7 is a flowchart illustrating an example of the procedure of a learning process of a relevance information deriving unit 400 according to the embodiment;

FIG. 8 is a flowchart illustrating an example of the procedure of an information delivery process according to the embodiment;

FIG. 9 is a graph illustrating a first example of the information delivery device 10 according to the embodiment;

FIG. 10 is a diagram illustrating a second example of the information delivery device 10 according to the embodiment;

FIG. 11 is a diagram illustrating a third example of the information delivery device 10 according to the embodiment; and

FIG. 12 is a diagram illustrating a fourth example of the information delivery device 10 according to the embodiment.

### DETAILED DESCRIPTION OF THE PREFERRED EMBODIMENT

The following describes an embodiment of an information processing system, a method of information processing, and a non-transitory computer-readable recording medium having stored therein a computer program according to the present embodiment with reference to the accompanying drawings. In the present embodiment, an information delivery device is described that implements the information processing system. The information delivery device is communicably connected to user devices via a network such as the Internet, and delivers various types of information to the user devices. The information delivery device according to the present embodiment derives relevance information by learning on the basis of the content of content items delivered to users and information about locations of users who have accessed the content items. The relevance information associates a factor included in the content of a content item with a specific area. The information delivery device can determine the delivery destination of a content item including a local topic on the basis of the derived relevance information. The embodiment will be described below.

1. Configuration of Information Delivery Device

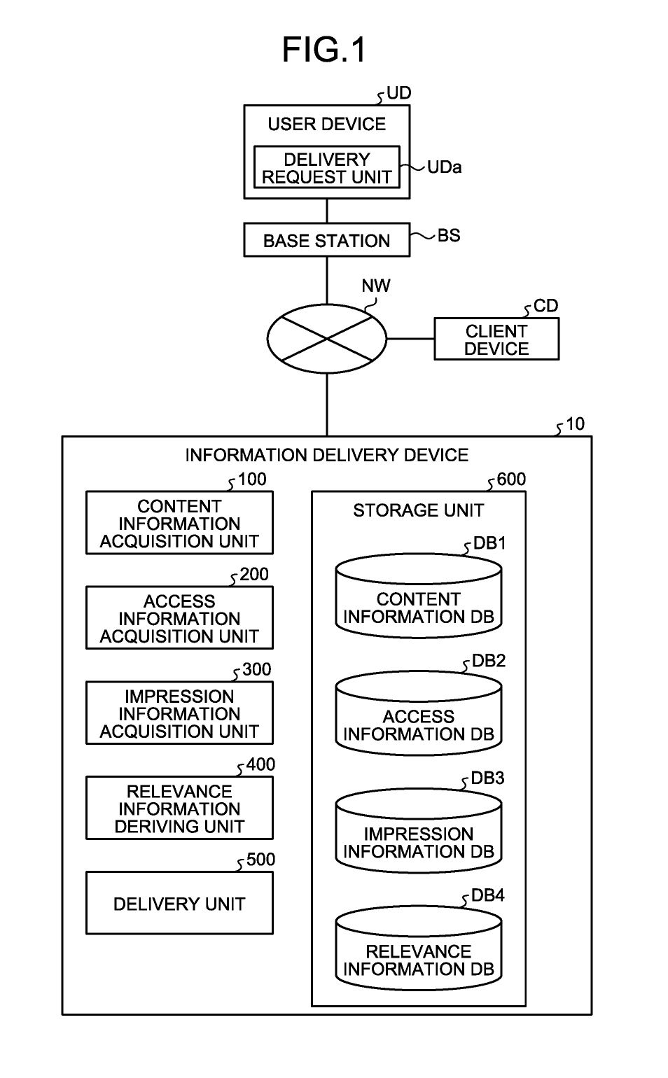

FIG. 1 is a diagram illustrating usage environment of an information delivery device 10 according to the embodiment. The information delivery device 10 is communicably connected to a user device UD and a client device CD via a network NW. The network NW includes, for example, the Internet, a wide area network (WAN), and a local area network (LAN). The information delivery device 10 is communicably connected to, for example, a plurality of user devices UD and a plurality of client devices CD.

The user device UD is an information processing device used by a user who is a receiver of a content item. The user uses the user device UD to view the content item. The user device UD may have, for example, a browser or an application program for viewing the content item provided by the information delivery device 10. In this case, the user device UD causes a processor of the user device UD to execute the browser or the application program, and implements a delivery request unit UDa.

Upon transmitting a delivery request for a content item to the information delivery device 10, the delivery request unit UDa transmits location information of the user device UD (location information of the user) in addition to the delivery request for the content item. The location information of the user device UD indicates, for example, a latitude and a longitude at which the user device UD is located. Such location information of the user device UD is acquired by, for example, a global positioning system (GPS) unit installed in the user device UD.

The user device UD does not necessarily transmit the location information of its own. In this case, the information delivery device 10 may acquire information about the location of the user on the basis of, for example, the IP address of a base station (BS) through which the user device UD accesses the network NW. Further details will be described later in the description of the information delivery device 10.

The client device CD is an information processing device used by a client who is a provider of a content item. The client device CD registers the content item to be delivered to user devices UD in the information delivery device 10.

The term “content item” in this description refers to, for example, an article, such as news or a column, including text data. The term “content item” may refer to a content item that does not include text data, such as an image or a video. The “content item” is reproduced by the browser or the application program. In the description of the present embodiment, for example, the content item is an article including text data.

The information delivery device 10 stores therein content items registered by client devices CD, and upon reception of a delivery request for a content item from a user device UD, delivers the stored content item to the user device UD.

More specifically, the information delivery device 10 includes, for example, a content information acquisition unit 100, an access information acquisition unit 200, an impression information acquisition unit 300, a relevance information deriving unit 400, a delivery unit 500, and a storage unit 600.

The content information acquisition unit 100, the access information acquisition unit 200, the impression information acquisition unit 300, the relevance information deriving unit 400, and the delivery unit 500 may be functional units (hereinafter referred to as “software functional units”) that are implemented by causing the processor of the information delivery device 10 to execute a computer program, may be implemented by hardware such as a large scale integration (LSI), an application specific integrated circuit (ASIC), or a field-programmable gate array (FPGA), or may be implemented through cooperation of the software functional units with the hardware.

The storage unit 600 is implemented by, for example, a random access memory (RAM), a read only memory (ROM), a hard disk drive (HDD), or a flash memory, or a hybrid storage device that is a combination of some of these memories. All or part of the storage unit 600 may be implemented by an external device such as a network attached storage (NAS) or an external storage server that can be accessed by the processor of the information delivery device 10. The storage unit 600 stores therein a content information database DB1, an access information database DB2, an impression information database DB3, and a relevance information database DB4.

Each functional unit of the information delivery device 10 will be described more specifically below.

First, the content information acquisition unit 100 will be described. The content information acquisition unit 100 receives a content item to be delivered to user devices UD from a client device CD via the network NW. The content information acquisition unit 100 adds, to the content item received from the client device CD, a content ID for identifying the content item and registers the content item in the content information database DB1 in association with the content ID.

The content information acquisition unit 100 derives, on the basis of the content of the acquired content item, a content vector that represents the content of the content item in the form of a vector representation. The content vector is, for example, a sparse vector that represents the content of the content item in a local representation.

Specifically, the content information acquisition unit 100 acquires, from the content information database DB1, data (e.g., text data) of the content item from which a sparse vector is derived. The content information acquisition unit 100 extracts words included in the content item by performing morphological analysis. The content information acquisition unit 100 narrows the extracted words down by using, for example, term frequency-inverse document frequency (tf-idf) and replaces the resulting words with numerical values, thereby deriving a sparse vector representing the content of the content item. The content information acquisition unit 100 associates the derived sparse vector with the content ID and registers them in the content information database DB1. The sparse vector representing the content of the content item is an example of information (first information, content information) about the content of the content item.

The “first information” is not limited to a sparse vector. For example, the “first information” may be a dense vector that is a distributed representation of the content of a content item. The dense vector is derived by compressing the dimensionality of the sparse vector that represents the content of the content item. If the content information acquisition unit 100 is configured to receive learning data to be described later from an external device, the content information acquisition unit 100 may receive the sparse vector or the dense vector, which has already been derived for each content item, from the external device. The sparse vector or the dense vector received from the external device is an example of the “first information”.

Described next is the access information acquisition unit 200. The access information acquisition unit 200 receives a delivery request for a content item from a user device UD via the network NW. When the access information acquisition unit 200 according to the present embodiment receives a delivery request for a content item, the access information acquisition unit 200 acquires, from the user device UD, information (e.g., content ID) indicating the content item requested by the user device UD and the location information of the user device UD that has transmitted the delivery request. The location information of the user device UD is an example of information (second information, access location information) about the location of the user who has accessed the content item. The access information acquisition unit 200 registers the information indicating the accessed content item and the location information of the user who has accessed the content item in an association table T1 stored in the access information database DB2.

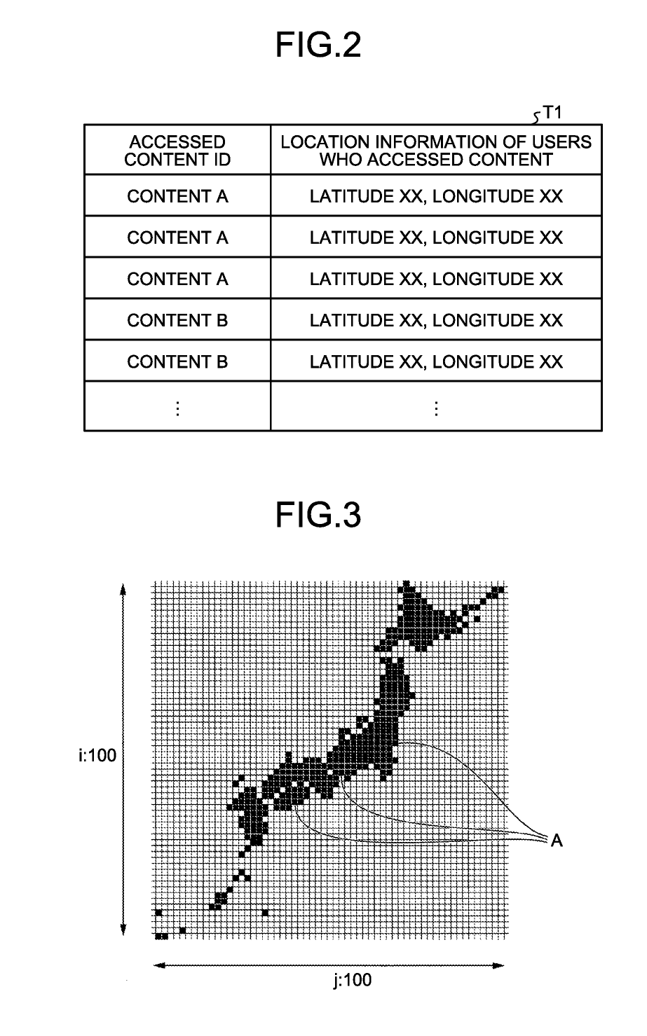

FIG. 2 is a diagram illustrating an example of the content of the association table T1 according to the present embodiment. As illustrated in FIG. 2, the association table T1 associates, for example, content IDs of accessed content items with information about the locations of users who have accessed the content items, and manages them.

The phrase “information about the location of the user” is not limited to the location information of the user device UD. For example, the access information acquisition unit 200 may acquire the IP address of a base station BS through which the user device UD accesses the network NW and may deem the location of the base station BS having the acquired IP address to be the location of the user. The IP address of the base station BS acquired by the access information acquisition unit 200 is another example of information (second information, access location information) about the location of the user.

The term “specific areas” according to the present embodiment will be described. Each “specific area” corresponds to an area out of a plurality of divided areas of a whole region (e.g., a whole country or the whole world) to which content items are delivered. “Specific areas” are associated with factors (place names or proper nouns) included in the content of content items about local topics. Each factor (place name or proper noun) included in the content of content items is not necessarily associated with a single specific area, and may be associated with a plurality of specific areas.

FIG. 3 is a diagram illustrating an example of how specific areas A are set in the present embodiment. As illustrated in FIG. 3, the specific areas A according to the present embodiment are defined by, for example, grid lines that segment the whole region to which content items can be delivered. Each specific area A is distinguished from neighboring specific areas A on the basis of, for example, information of a latitude and a longitude. In the following description, a set of “i” and “j” represents the positional coordinate of a specific area A in the whole region to which content items can be delivered.

The access information acquisition unit 200 according to the present embodiment specifies, on the basis of information (e.g., content ID) indicating a content item accessed by a user and information about the location of the user who has accessed the content item, a specific area A in which the user who has accessed the content item is located (specifies in which specific area A the user is located). The access information acquisition unit 200 adds up the number of accesses to each of the content items for each specific area A. The access information acquisition unit 200 then registers the information (e.g., content IDs) indicating the accessed content items and the number of accesses to each of the accessed content items for each specific area A in an association table T2 stored in the access information database DB2.

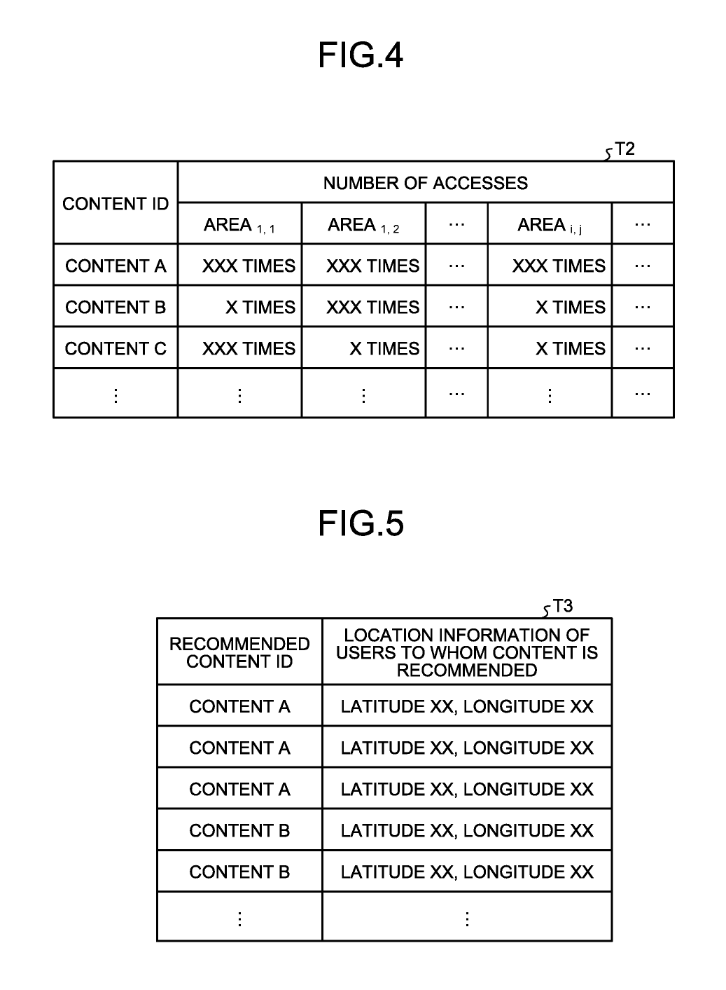

FIG. 4 is a diagram illustrating an example of the content of the association table T2 according to the present embodiment. As illustrated in FIG. 4, the association table T2 associates, for example, the content IDs of the accessed content items with the number of accesses to each of the content items for each specific area A, and manages them.

If the access information acquisition unit 200 is configured to receive learning data to be described later from an external device, the access information acquisition unit 200 may receive the information, which has already been derived, indicating the number of accesses to each of the content items for each specific area A from the external device. The information, received from the external device, indicating the number of accesses to each of the content items for each specific area A is an example of the “second information”.

Described next is the impression information acquisition unit 300. In the present embodiment, the delivery unit 500 delivers recommendation information for recommending content items to the users. The “recommendation information” is information including, for example, the title of a content item or text data or an image representing the outline of the content item, and the link (hyperlink) to the content item. The impression information acquisition unit 300 according to the present embodiment acquires information about the location of a user to whom the recommendation information is delivered, on the basis of the location information of the user device UD to which the recommendation information is delivered or on the basis of the IP address of a base station BS. The impression information acquisition unit 300 registers information (e.g., content ID) indicating the content item recommended to the user and information about the location of the user to whom the content item is recommended in an association table T3 stored in the impression information database DB3.

FIG. 5 is a diagram illustrating an example of the content of the association table T3 according to the present embodiment. As illustrated in FIG. 5, the association table T3 associates, for example, content IDs of content items recommended to users with information about the location of the users to whom the content items are recommended, and manages them.

The impression information acquisition unit 300 according to the present embodiment specifies a specific area A at which the user is located to whom the content item is recommended (specifies in which specific area A the user is located), on the basis of information indicating a content item recommended to a user and information about the location of the user to whom the content item is recommended. The impression information acquisition unit 300 adds up the number of impressions to each of the content items for each specific area A. “The number of impressions” is the number of times that the information recommending a certain content item has been displayed on a display screen of the user devices UD. The impression information acquisition unit 300 registers information (e.g., content IDs) indicating content items recommended to users and the number of impressions to each of the content items for each specific area A in an association table T4 stored in the impression information database DB3.

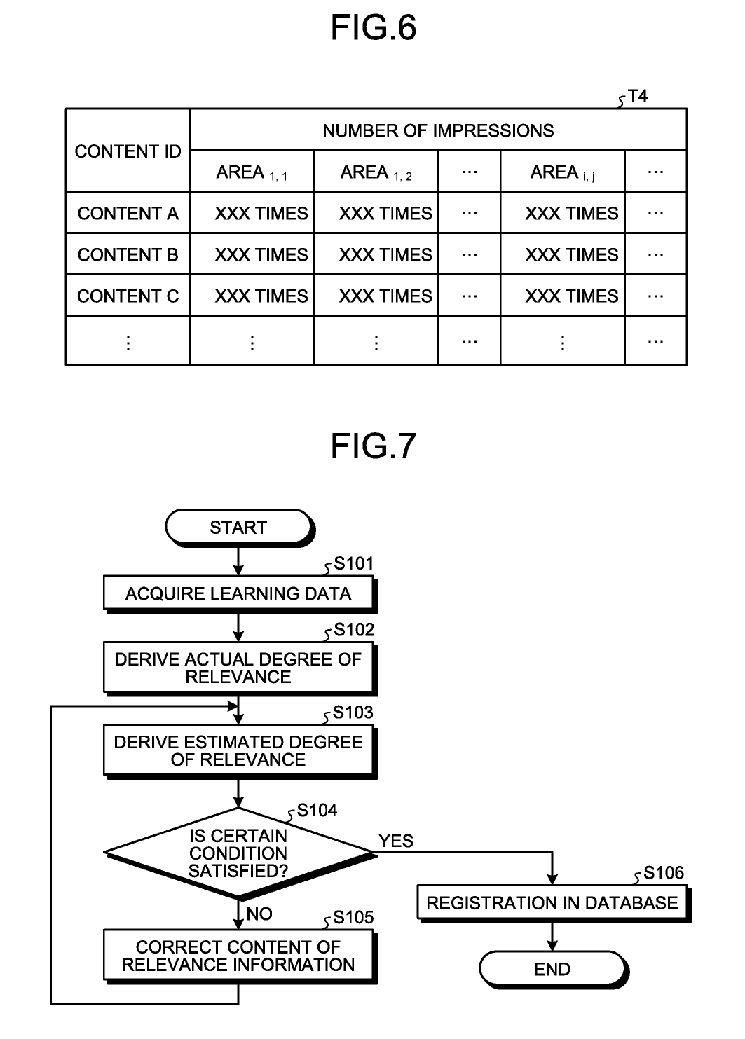

FIG. 6 is a diagram illustrating an example of the content of the association table T4 according to the present embodiment. As illustrated in FIG. 6, the association table T4 associates, for example, content IDs of recommended content items with the number of impressions to each of the content items for each specific area A, and manages them.

If the impression information acquisition unit 300 is configured to receive learning data to be described later from an external device, the impression information acquisition unit 300 may receive the information, which has already been derived, indicating the number of impressions to each of the content items for each specific area A, from the external device.

Described next is the relevance information deriving unit 400. Based on the information about the content of a content item acquired by the content information acquisition unit 100 and the information, acquired by the access information acquisition unit 200, about the location of the user who has accessed the content item, the relevance information deriving unit 400 derives relevance information that associates a factor (place name or proper noun) included in a content item with a specific area A having a high relevance to the factor. In the present embodiment, the relevance information deriving unit 400 derives the relevance information by learning using, as training data, information indicating the content of a plurality of content items that were delivered in the past and information indicating the locations of users who have accessed the content items. The relevance information is an example of “third information”.

Specifically, let a content vector (e.g., sparse vector) indicative of the content of a content item n be xₙ, and an index indicative of the relevance of the content item n to a specific area A_{i,j} be y_{n,i,j˜}, then the relevance information can be expressed as a function F_{i,j} given by Equation (1). For example, the function F_{i,j} outputs a large value when the content item n has a high relevance to the specific area A_{i,j}. In the present embodiment, the function F_{i,j} is learned by machine learning using the training data described above. The reference sign “n” represents the identification number of the content item.

\tilde{y}_{n,i,j}=F_{i,j}(xₙ) (1)

For example, the function may be represented as a vector (hereinafter referred to as a “relevance vector”) indicative of the relevance of the content vector xₙ to the specific area A_{i,j}. Let a relevance vector indicative of the relevance of the content vector xₙ to the specific area A_{i,j} be r_{i,j}, for example, then the function F_{i,j} may be expressed as r_{i,j}^{T}xₙ. If, for example, the relevance of the content vector xₙ to the specific area A_{i,j} increases, or the relevance vector r_{i,j} increases, r_{i,j}^{T}xₙ increases. In this case, the relevance vector r_{i,j} is learned by machine learning using the training data described above. The function F_{i,j} is not limited to the examples above.

An example of a learning process of the relevance information deriving unit 400 will be described more specifically below.

First, the definition of a “click rate” is described. The click rate refers to a click through rate (CTR) that is calculated by dividing the number of accesses (number of clicks) to a content item by the number of times (number of impressions) the content item has been recommended. The “click rate” is an example of “responsiveness to a content item”. The term “click” in the present embodiment is not limited to an operation of pushing and releasing a button of a mouse or the like, and includes a tapping operation on an input device through a touch screen.

In the present embodiment, the relevance information deriving unit 400 acquires the number of clicks to each of the content items for each specific area A by referring to the association table T2 in the access information database DB2. The relevance information deriving unit 400 acquires the number of impressions to each of the content items for each specific area A by referring to the association table T4 in the impression information database DB3.

The relevance information deriving unit 400 derives a click rate CTRₙ of each of the content items for the entire region on the basis of Equation (2). “Clicks_{n,i,j}” represents the actual number of clicks to each of the content items for each specific area A. “Imps_{n,i,j}” represents the number of impressions to each of the content items for each specific area A.

$${CTR}_{n} = \frac{{\sum }_{i , j}^{ } {Clicks}_{n , i , j}}{{\sum }_{i , j} {Imps}_{n , i , j}} \qquad ( 2 )$$

The relevance information deriving unit 400 derives a click rate CTR_{n,i,j} of each of the content items for each specific area A based on Equation (3).

$${CTR}_{n , i , j} = \frac{{Clicks}_{n , i , j} + α {CTR}_{n}}{{Imps}_{n , i , j} + α} \qquad ( 3 )$$

Here, α represents a correction value for alleviating the difference in the population density between the specific areas A. In other words, a large number of clicks are obtained in a specific area A (e.g., urban area) having high population density, where, if some users perform unusual click operations, such unusual operations are less likely to affect the overall trends. In a specific area A (e.g., mountainous area) having low population density, however, a small number of clicks are obtained, and if some users perform unusual click operations, such unusual operations may largely affect the overall trend. Examples of “unusual click operations” include an accidental access to a content item about a local topic by a user located in a specific area A that is not related to the content item.

In the present embodiment, the click rate for each specific area A is derived on the basis of the actual number of clicks obtained in each specific area A and the correction value α. With this configuration, even if some users perform unusual click operations in a specific area A having low population density, such unusual click operations will not largely affect the overall trend. The value of α, which is not limited to a certain value, ranges from, for example, several tens to several hundreds.

The relevance information deriving unit 400 derives y_{n,i,j} that is an index (hereinafter referred to as “degree of relevance”) indicative of the relevance of the content of a content item to a specific area A on the basis of Equation (4).

$${y}_{n , i , j} = \frac{{CTR}_{n , i , j} - {E}_{i , j} [ {CTR}_{n , i , j} ]}{{σ}_{i , j} [ {CTR}_{n , i , j} ]} \qquad ( 4 )$$

Here, E_{i,j}[CTR_{n,i,j}] is an averaged click rate calculated such that all the click rates CTR_{n,i,j} derived for each specific area A on the basis of Equation (3) are added up and the sum is divided by the total number of specific areas A. That is, E_{i,j}[CTR_{n,i,j}] is the average click rate of each of the content items calculated for a plurality of specific areas A (all of the specific areas A). In other words, the relevance information deriving unit 400 derives the relevance information on the basis of the responsiveness to the content item for each specific area A and the average responsiveness to the content item calculated for a plurality of specific areas A.

In Equation (4), σ_{i,j}[CTR_{n,i,j}] represents the standard deviation of the click rate CTR_{n,i,j}. In other words, the degree of relevance y_{n,i,j} obtained by Equation (4) is a normalized representation of the click rate CTR_{n,i,j} for each specific area A. Without normalization, for example, the value obtained by Equation (3) only represents whether the CTR_{n,i,j} of the content item is high or low. In the present embodiment, performing the normalization using Equation (4) can determine to which extent each specific area A relates to the content item. For example, Equation (4) outputs a value close to zero if the content of a content item has a low relevance to a specific area A. Equation (4) outputs a higher value as the content of the content item has a higher relevance to the specific area A.

The relevance information deriving unit 400 derives L(xₙ) on the basis of Equation (5).

$$L ( {x}_{n} ) = {\sum }_{i , j} \{ ( 1 - β ) {( {\tilde{y}}_{n , i , j} - {y}_{n , i , j} )}^{2} + {β ( {\tilde{y}}_{n , i , j} - \frac{1}{\vert {N}_{i , j} \vert} {\sum }_{( {i}^{′} , {j}^{′} ) ∈ {N}_{i , j}} {\tilde{y}}_{n , {i}^{′} , {j}^{′}} )}^{2} \} \qquad ( 5 )$$

Here, y_{n,i,j} is an actual degree of relevance derived by Equation (4) based on learning data, whereas y_{n,i,j˜} is an estimated degree of relevance derived by using the function F_{i,j} given by Equation (1) to be learned. The first term of Equation (5) represents a squared error between the estimated degree and the actual degree. The second term of Equation (5) represents a squared error between an estimated degree of relevance of a specific area Ai,j to the content item and an estimated degree of relevance of a neighboring area A_{i′,j′} to be described later to the content item. β is a constant that determines the ratio of the first term to the second term, and the value is optional.

In the present embodiment, the relevance information deriving unit 400 learns the function given by Equation (1) to be learned, by using the learning data described above to minimize L(xₙ) given by Equation (5). With this configuration, the relevance information deriving unit 400 can derive the function F_{i,j} that associates a factor included in the content of a content item with a specific area A having a high relevance to the factor.

Even if Equation (5) only includes the first term above, the relevance information deriving unit 400 can implement machine learning to derive the function F_{i,j}. In the present embodiment, since Equation (5) includes the second term, the relevance information deriving unit 400 can derive the function more accurately.

Specifically, “i′” and “j′” in Equation (5) represent positional coordinates of a neighboring area A_{i′,j′} located near the specific area A_{i,j}. The neighboring area A_{i′,j′} is an area located adjacent to any one of the four sides of the specific area A_{i,j}. In Equation (5), minimizing the second term means performing regularization so that the degree of relevance of the specific area A_{i,j} to the content item will not separate from the degree of relevance of the neighboring area A_{i′,j′} to the content item by a certain degree or more. In other words, the relevance information deriving unit 400 derives the function F_{i,j} by fitting a first degree of relevance of the specific area A_{i,j} to a content item and a second degree of relevance of the neighboring area A_{i′,j′} to the content item to a smooth distribution in which the first degree of relevance does not separate from the second degree of relevance by a certain degree or more. The specific area A_{i,j} is an example of a “first specific area”. The neighboring area A_{i′,j′} is an example of a “second specific area”. In the second term above, regularization is performed such that the first degree of relevance of the specific area A_{i,j} does not separate from the average of second degrees of relevance of a plurality of neighboring areas A_{i′,j′} by a certain degree or more. In Equation (5), “N” represents the number of neighboring areas A_{i′,j′} to be compared with the specific area A_{i,j}.

The relevance information deriving unit 400 registers information representing the derived function F_{i,j} in the relevance information database DB4. In other words, the relevance information deriving unit 400 registers the relevance information derived through the learning process above in the relevance information database DB4.

Described next is the delivery unit 500. When the information delivery device 10 receives a delivery request for a content item from a user device UD, the delivery unit 500 acquires the requested content item from the content information database DB1 and delivers the acquired content item to the user device UD.

If there is a delivery candidate content item, the delivery unit 500 according to the present embodiment determines the locality of the delivery candidate. In other words, the delivery unit 500 determines a specific area A relating to the content of the delivery candidate content item on the basis of the information (e.g., sparse vector) indicating the content of the delivery candidate content item and the relevance information derived by the relevance information deriving unit 400. For example, the delivery unit 500 determines the specific area A relating to the content of the content item on the basis of an output of the function F_{i,j} to which information indicating the content of the content item is input. The delivery unit 500 delivers the content item only to the specific area A relating to the content of the content item.

2. Procedure Performed by Information Delivery Device

Described next is the procedure of a process performed by the information delivery device 10.

2-1. Learning Process of Relevance Information Deriving Unit 400

FIG. 7 is a flowchart illustrating an example of the procedure of a learning process of the relevance information deriving unit 400 according to the present embodiment. As illustrated in FIG. 7, in the learning process of the relevance information deriving unit 400, first, the relevance information deriving unit 400 acquires training data (S101). The training data includes, for example, information about the content of a plurality of content items accessed in the past, information about the locations of users who have accessed the content items, and information about the locations of users to whom the content items were recommended. All or part of the training data may be data stored in the databases DB1, DB2, and DB3, or may be data newly registered from an external device.

Next, the relevance information deriving unit 400 derives an actual degree y_{n,i,j} of relevance of a specific area A to each of the content items on the basis of the learning data and Equation (4) (S102). The relevance information deriving unit 400 derives an estimated degree y_{n,i,j˜} of relevance of the specific area A to each of the content items on the basis of the function F_{i,j} to be learned (S103). The relevance information deriving unit 400 determines whether Equation (5) is minimized (S104).

If no at S104, the relevance information deriving unit 400 corrects the content of the function F_{i,j} (S105). The relevance information deriving unit 400 repeats the process of S103 and S104 by using the corrected function F_{i,j}.

If yes at S104, the relevance information deriving unit 400 registers the resulting function F_{i,j} in the relevance information database DB4 as relevance information that associates a factor included in the content of a content item with a specific area A (S106). The learning process of the relevance information deriving unit 400 is ended.

2-2. Information Delivery Process for Delivering Content Item Including Local Topics

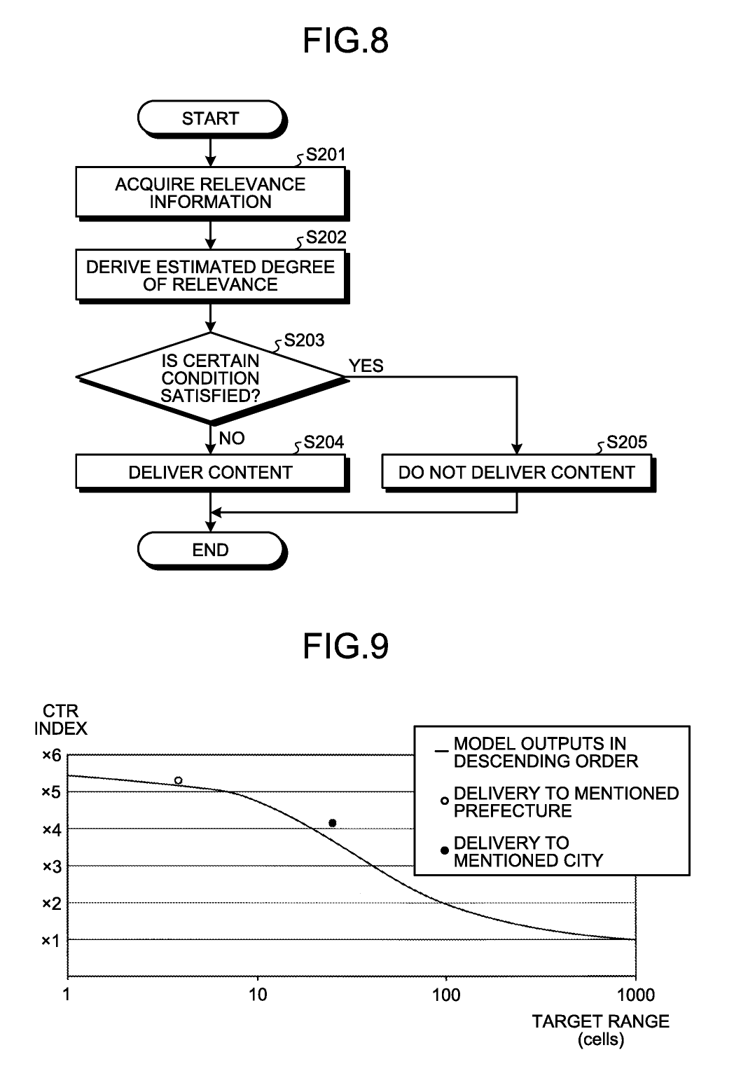

Described next is an information delivery process for delivering a content item including local topics. FIG. 8 is a flowchart illustrating an example of the procedure of an information delivery process according to the present embodiment. As illustrated in FIG. 8, the delivery unit 500 acquires, from the relevance information database DB4, the function F_{i,j} derived by the relevance information deriving unit 400 through the learning process (S201).

The delivery unit 500 derives an estimated degree y_{n,i,j˜} of relevance of a delivery candidate content item to each specific area A on the basis of the information indicating the content of the delivery candidate content item and the acquired function F_{i,j} (S202). The delivery unit 500 determines whether the estimated degree y_{n,i,j˜} of relevance of each specific area A satisfies a certain condition (e.g., whether the estimated degree is equal to or higher than a certain threshold) (S203).

If yes with regard to a certain specific area A at S203, the delivery unit 500 delivers the content item to the specific area A (S204). If no with regard to a certain specific area A at S203, the delivery unit 500 does not deliver the content item to the specific area A (S205). The process of delivering a content item including local topics is ended.

3. Results of Locality Estimation Experiments

Lastly, some examples of locality estimation are described. The locality estimation is performed by actually using the information delivery device 10 above.

### 3-1. First Example

FIG. 9 is a graph illustrating a first example of the information delivery device 10 according to the embodiment. The indication in FIG. 9 labeled as “delivery to mentioned prefecture” indicates a CTR index obtained such that a place name (mentioned location) included in each content item is manually added to the content item, and when the content item is delivered to the prefecture to which the added mentioned location belongs, the CTR index is calculated. In the same manner, the indication labeled as “delivery to mentioned city” indicates a CTR index calculated when the content item is delivered to the city to which the added mentioned location belongs. The indication labeled as “model outputs in descending order” indicates a CTR index calculated when the content item is delivered to specific areas A selected by the information delivery device 10 according to the present embodiment. “Target range (cells)” represents the number of specific areas A selected as delivery areas.

As illustrated in FIG. 9, the information delivery device 10 according to the present embodiment can deliver a content item to a specific area A relating to the content item with substantially the same accuracy compared to the case in which the place names are manually added to the content items, in both cases in which the content item is delivered to the “mentioned city” and in which the content item is delivered to the “mentioned prefecture”.

### 3-2. Second Example

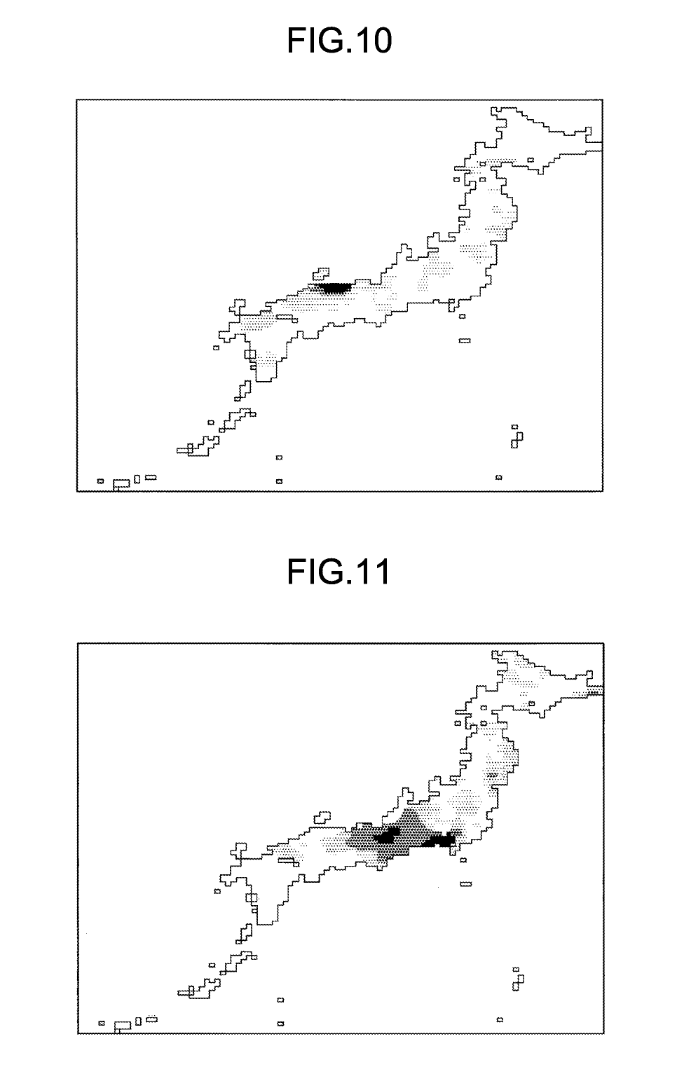

FIG. 10 is a diagram illustrating a second example of the information delivery device 10 according to the embodiment. FIG. 10 illustrates specific areas A selected by the information delivery device 10 upon registration of an article in the information delivery device 10. The content item registered in the information delivery device 10 in the second example is, for example, an article reporting the Tottori earthquake, for example, “[Tottori earthquake, 47 buildings in dangerous condition] four buildings completely or partially destroyed, in the stricken area of the earthquake that hit the central area of Tottori prefecture, etc.”. In this case, as illustrated in FIG. 10, the information delivery device 10 selects specific areas A at and around the Tottori region.

### 3-3. Third Example

FIG. 11 is a diagram illustrating a third example of the information delivery device 10 according to the embodiment. FIG. 11 illustrates specific areas A selected by the information delivery device 10 upon registration of a single word in the information delivery device 10. The “single word” refers to an imaginary article composed of a single word, unlike the ordinary articles including a plurality of words, and the single word is input to the information delivery device 10 to visualize the estimation function of the information delivery device 10. The single word registered in the information delivery device 10 in the third example is “Tokaido-Shinkansen”. In this case, as illustrated in FIG. 11, specific areas A along the Tokaido-Shinkansen railway are selected by the information delivery device 10.

### 3-4. Fourth Example

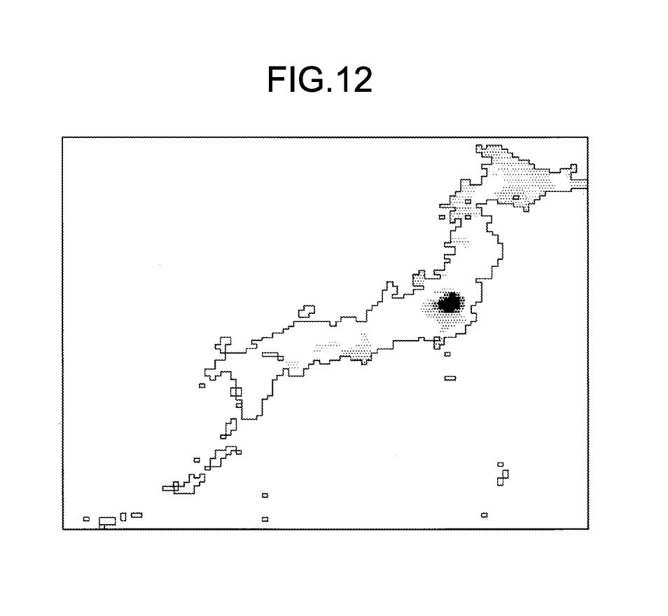

FIG. 12 is a diagram illustrating a fourth example of the information delivery device 10 according to the embodiment. FIG. 12 illustrates specific areas A selected by the information delivery device 10 upon registration of a single word in the information delivery device 10, in the same manner as in the third example. The single word registered in the information delivery device 10 in the fourth example is “Sakushin”. “Sakushin” is a name of a school located in Utsunomiya, Tochigi Prefecture. In this case, as illustrated in FIG. 12, specific areas A at and around Utsunomiya are selected by the information delivery device 10.

The information delivery device 10 having the configuration above can easily specify areas relating to a content item. Delivering a content item on the basis of the place name included in the content item generally involves the following problems. The first problem involves creation of dictionary data that connects a factor included in the content item with a specific area. Creation of dictionary data requires, for example, manual registration of place names in the dictionary data one by one. To register a newly introduced place name in the dictionary data, the dictionary data needs regular maintenance work. The second problem involves a manual annotation process (process for associating place names with specific areas), which is required when a plurality of place names are included in a single content item. The third problem involves difficulty in determining, in some cases, how far an area may be away from an area of an existing place name to be an area relevant to the place name (difficult to determine to which areas the content item needs to be delivered).

The information delivery device 10 according to the embodiment includes the relevance information deriving unit 400 that derives relevance information on the basis of information about the content of a content item acquired by the content information acquisition unit 100 and information, acquired by the access information acquisition unit 200, about locations of users who have accessed the content item. The relevance information associates a factor included in the content of a content item with a specific area. With this configuration, the relevance information that associates a factor included in the content of a content item with a specific area can be derived based on the information about locations of users who reacted to the content item. Thus, manual efforts to create the dictionary data described above can be reduced or eliminated. This configuration can also determine the range of how far an area may be away from an area of an existing place name to be an area relevant to the content name (determine to which areas the content item needs to be delivered) on the basis of objective data.

With regard to some proper nouns other than place names, such as a name of a person or a name of a facility, it is difficult to determine to which areas the nouns relate. In this regard, connecting proper nouns other than place names, such as a name of a person or a name of a facility, with specific areas by manual efforts is not an easy task. With the configuration of the embodiment, the relevance information deriving unit 400 can easily derive, on the basis of the information about locations of users who reacted to content items, the relevance information that associates a proper noun other than a place name, such as a name of a person or a name of a facility, with a specific area. With this configuration, an area relating to the content of a content item can be specified more accurately.

In the embodiment above, the relevance information deriving unit 400 derives the relevance information by learning using, as training data, a plurality of content items that were delivered in the past and the locations of the users who have accessed the content items. With this configuration, the relevance information can be accurately derived through learning on the basis of past delivery results. In other words, the training data according to the embodiment uses reactions of users that were collected in the past as correct information, which eliminates manual registration of the correct information. In this regard, manual efforts can be reduced.

In the embodiment above, the relevance information deriving unit 400 derives responsiveness to a content item for each specific area A on the basis of the information acquired by the access information acquisition unit, and derives the relevance information on the basis of the responsiveness derived for each specific area A. With this configuration, the relevance information can be derived on the basis of the distribution of the locations of the users who reacted to the content item. Thus, the relevance information can be derived more accurately.

In the embodiment above, the responsiveness indicates a click rate derived for each specific area A on the basis of the number of times that the content item has been recommended to users located in the specific area A and the number of accesses to the content item by users located in the specific area A. With this configuration, the responsiveness to the content item in each specific area A can be derived by using information that can be relatively easily collected.

Various aspects of the information delivery device 10 have been described, but the embodiment is not limited to the aspects described above. For example, content items are not limited to text data. When a content item is an image or a video, values indicating the gray scale or hues of the content item can be used as the information (first information) about the content of the content item.

In the present embodiment, the term “based on XX” means “at least based on XX”, and XX may include other elements in addition to XX. The term “based on XX” is not limited to a case of directly using XX, and XX may include calculated or processed XX. “XX” is optional.

According to an aspect of the present embodiment, an area related to a content item can be easily specified.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a first acquisition unit that acquires first information about content of a content item;
a second acquisition unit that acquires second information about a location of a user who has accessed the content item; and
a deriving unit that derives third information based on the first information acquired by the first acquisition unit and the second information acquired by the second acquisition unit, the third information associating a factor included in the content of the content item with a specific area out of a plurality of specific areas.

2. The information processing system according to claim 1, wherein
the deriving unit derives the third information by learning using, as training data, the first information about content of a plurality of content items that were delivered in the past and the second information about locations of users who have accessed the content items.

3. The information processing system according to claim 1, wherein
the deriving unit derives responsiveness to the content item for each of the specific areas based on the second information and derives the third information based on the derived responsiveness of each specific area.

4. The information processing system according to claim 3, wherein
the responsiveness is derived based on number of times that the content item has been recommended to users located in the specific area and based on number of times users located in the specific area have accessed the content item.

5. The information processing system according to claim 3, wherein
the deriving unit derives the responsiveness of each of the specific areas based on an actual responsiveness of each specific area and based on a correction value for alleviating a difference in population density between the specific areas.

6. The information processing system according to claim 3, wherein
the deriving unit derives the third information based on the responsiveness to the content item for each of the specific areas and based on an average responsiveness to the content item for the specific areas.

7. The information processing system according to claim 1, wherein
the deriving unit derives the third information by fitting a degree of relevance of a first specific area to the content item and a degree of relevance of a second specific area to the content item, the second specific area being adjacent to the first specific area, to a distribution in which the degree of relevance of the first specific area does not separate from the degree of relevance of the second specific area by a certain degree or more.

8. A method of information processing, the method for causing a computer to perform:
acquiring first information about content of a content item;
acquiring second information about a location of a user who has accessed the content item; and
deriving third information based on the acquired first information and the acquired second information, the third information associating a factor included in the content of the content item with a specific area.

9. A non-transitory computer-readable storage medium having stored therein a computer program for causing a computer to perform:
acquiring first information about content of a content item;
acquiring second information about a location of a user who has accessed the content item; and
deriving third information based on the acquired first information and the acquired second information, the third information associating a factor included in the content of the content item with a specific area.
